(19) United States
(12) Patent Application Publication
(10) Pub. No.: US 2013/0314912 A1
(43) Pub. Date: Nov. 28, 2013

(54) LED LIGHT BULB WITH LARGE-ANGLE LIGHT EMISSION

(71) Applicant: CHIH-MIN CHANG, NEW TAIPEI CITY (TW)

(72) Inventor: CHIH-MIN CHANG, NEW TAIPEI CITY (TW)

(73) Assignee: PARA LIGHT ELECTRONICS CO., LTD., NEW TAIPEI CITY (TW)

(21) Appl. No.: 13/477,212

(22) Filed: May 22, 2012

(51) Int. Cl. F21V 7/05; F21V 17/08; F21V 7/04; F21V 7/00; F21V 29/00

(52) U.S. Cl. 362/235

(57) ABSTRACT

Disclosed is an LED light bulb with large-angle light emission, which includes a reflection structure, a cover, a circuit board, a heat dissipater, and a power connector. The reflection structure is detachably mounted to a top of the cover. The heat dissipater has a top end coupled to a bottom end of the cover. The circuit board includes at least one LED element mounted thereon. The circuit board is attached to the heat dissipater in such a way that the circuit board is housed in the cover to allow the at least one LED element to project light toward the cover and the reflection structure. The power connector is mounted to a bottom end of the heat dissipater.

### FIELD OF THE INVENTION

The present invention relates to an LED (Light-Emitting Diode) light bulb and in particular to an LED light bulb with large-angle light emission.

### BACKGROUND OF THE INVENTION

A conventional LED light bulb often comprises a heat dissipater, an LED light source, a cover, and a head. However, no reflective structure that is conveniently detachable is included in the conventional LED bulb. Further, the light emission angle of the conventional LED bulb is only around 150 degrees and the intensity of the emitting light on the rear and sides of the bulb is generally insufficient, making it lacking of sufficient brightness. These are long known problems.

Thus, the present invention aims to provide an LED light bulb that has a large angle of light emission and provides enhanced light intensity and brightness on the rear and sides of the blub.

### SUMMARY OF THE INVENTION

An object of the present invention is to provide an LED (Light-Emitting Diode) light bulb with large-angle light emission, which comprises a reflective structure that expands the light emission angle of the LED light bulb to around 270-330 degrees (namely large-angle emission of light) and enhances light intensity and brightness at the rear and sides of the bulb.

To achieve the above object, the present invention provides an LED light bulb with large-angle light emission, which comprises a reflection structure, a cover, a circuit board, a heat dissipater, and a power connector. The reflection structure is detachably mounted to a top of the cover. The heat dissipater has a top end coupled to a bottom end of the cover. The circuit board includes at least one LED element mounted thereon. The circuit board is attached to the heat dissipater in such a way that the circuit board is housed in the cover to allow the at least one LED element to project light toward the cover and the reflection structure. The power connector is mounted to a bottom end of the heat dissipater.

As such, the light emission angle of the LEG light bulb can be expanded to around 270-300 degrees and the light intensity and brightness at the rear and sides of the LED bulb can be enhanced. Further, a user is allowed to easily and conveniently remove and replace the reflection structure.

### BRIEF DESCRIPTION OF THE DRAWINGS

The present invention will be apparent to those skilled in the art by reading the following description of preferred embodiments thereof with reference to the drawings, in which:

FIG. 1 is an exploded view showing a first embodiment according to the present invention;

FIG. 2 is an exploded view showing a second embodiment according to the present invention;

FIG. 3 is an exploded view showing a third embodiment according to the present invention; and

FIG. 4 is an exploded view showing a fourth embodiment according to the present invention.

### DETAILED DESCRIPTION OF THE PREFERRED EMBODIMENTS

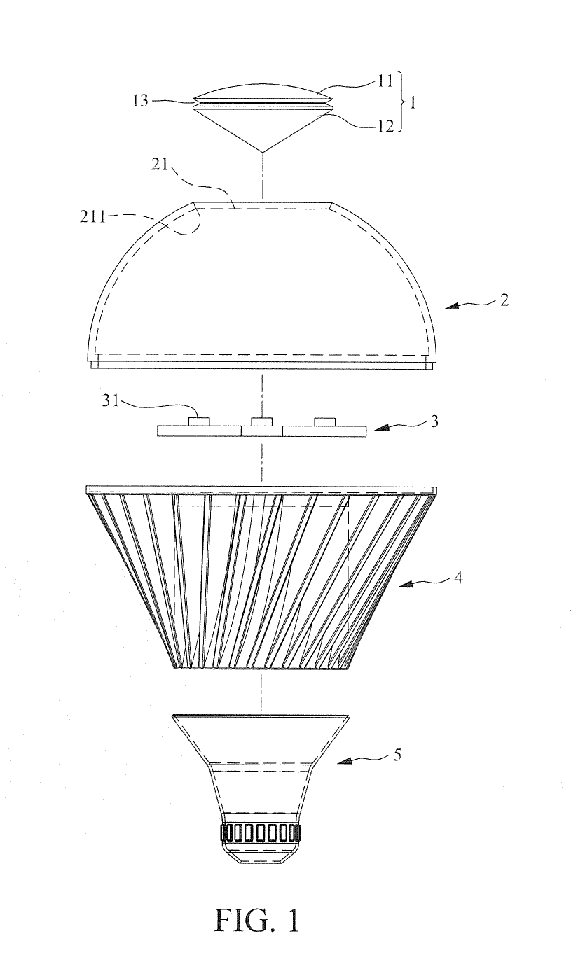

The present invention provides an LED (Light-Emitting Diode) light bulb with large-angle light emission, of which first, second, third, and fourth embodiments are respectively illustrated in FIGS. 1, 2, 3, and 4.

Reference is now made to the first embodiment of the present invention shown in FIG. 1, which comprises a reflection structure 1, a cover 2, a circuit board 3, a heat dissipater 4, and a power connector 5.

The reflection structure 1 comprises an optic curved surface that is of delicate and precise optic design, so that reflection of light can be effected through the optic curved surface. The reflection structure 1 is detachably mounted to a top of the cover 2 for easy and convenient removal and replacement. The heat dissipater 4 has a top end coupled to a bottom end of the cover 2. The circuit board 3 comprises at least one LED element 31. The circuit board 3 is attached to the heat dissipater 4 in such a way that the circuit board 3, especially the LED element 31 of the circuit board 3, can be housed in the cover 2 to allow light emitting from the LED element 31 to be projected to the cover 2 and the reflection structure 1. The power connector 5 is mounted to a bottom end of the heat dissipater 4.

With proper assembling of the above components, an LED light bulb with large-angle light emission according to the present invention is completed. When the light emitting from the LED element 31 is projected to the reflection structure 1, the reflection structure 1 reflects the circumferential portion of the light to the cover 2 in order to expand the light emission angle of the LED light bulb to around 270-330 degrees (namely large angle emission of light) and to enhance the intensity and brightness at the rear and sides of the LED light bulb.

The circuit board 3 is arranged at the top end of the heat dissipater 4 and, as shown in the drawings, is received inside the top end of the heat dissipater 4. The reflection structure 1 comprises a first portion 11 that protrudes outside the cover 2 and a second portion 12 that is received inside the cover 2. In the first embodiment shown in FIG. 1, the second portion 12 of the reflection structure 1 has a shape of circular cone. The cover 2 forms a hole 21 in a top thereof so that the reflection structure 1 is detachably received and fixed in the hole 21 of the cover 2. Specifically, the hole 21 of the cover 2 has an inner circumference along which a first joint rim 211 is formed. The reflection structure 1 has an outer circumference along which a second joint rim 13 is formed to correspond to the first joint rim 211. The second joint rim 13 of the reflection structure 1 is detachably engageable with the first joint rim 211 of the cover 2 to be fixed thereto, allowing a user to easily and conveniently remove and replace the reflection structure. In other words, the reflection structure 1 can be removed and substituted by another reflection structure.

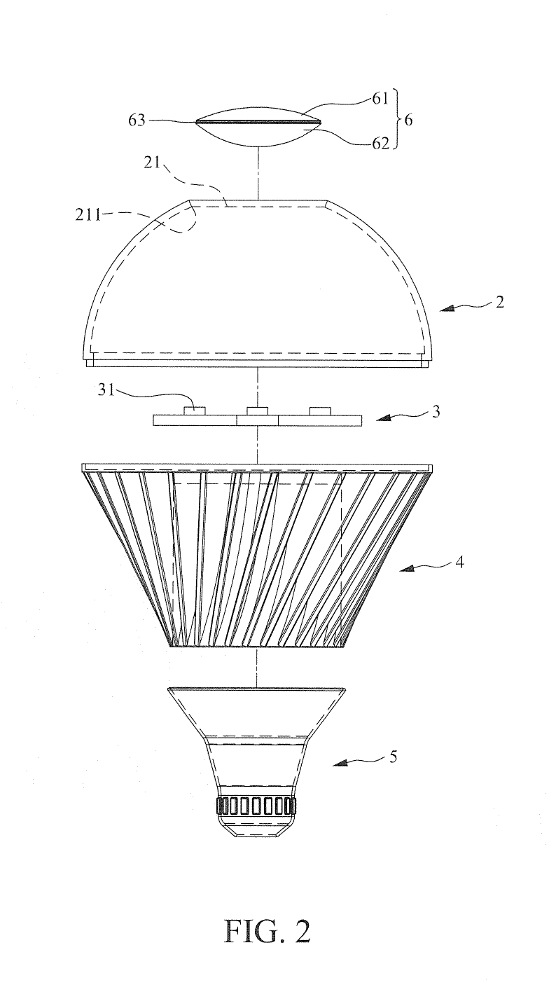

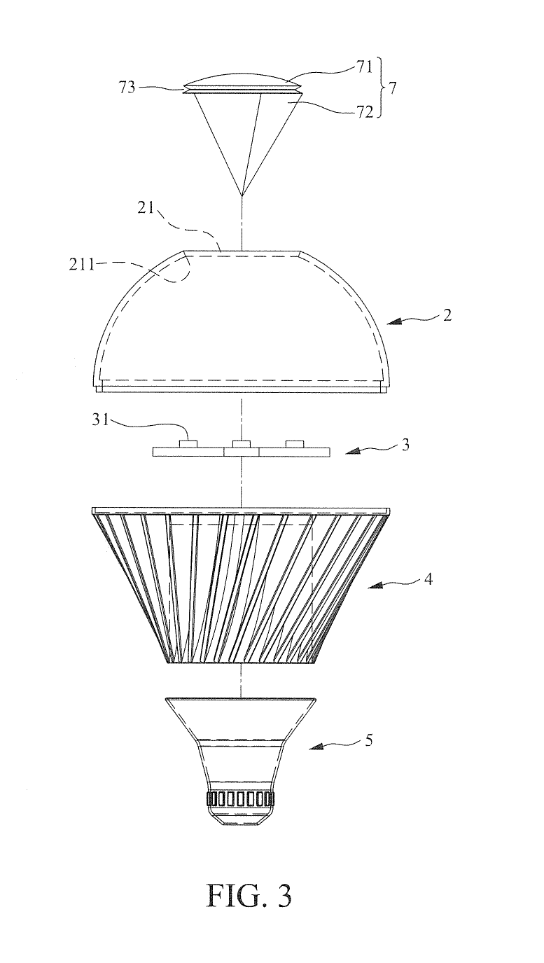

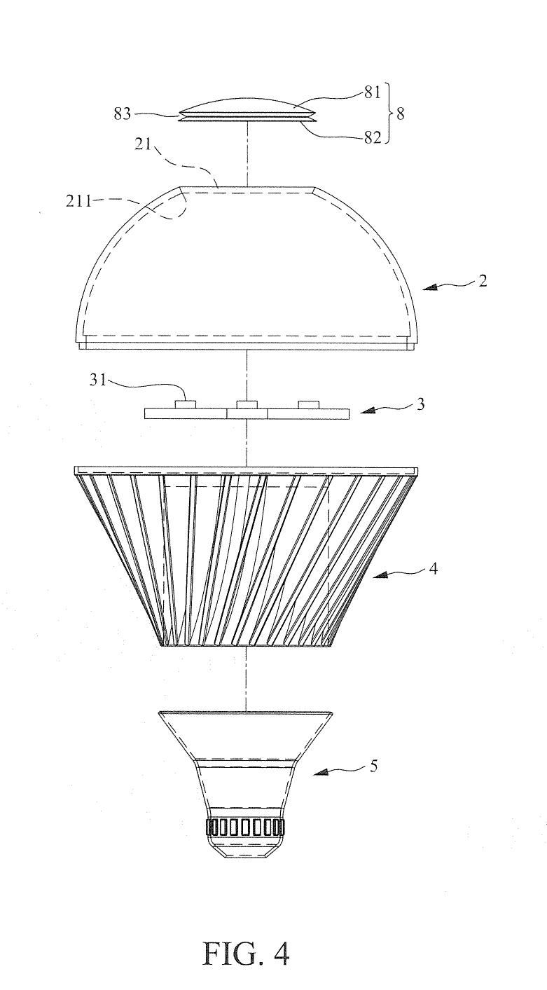

Reference is now made to the second, third, and fourth embodiments shown in FIGS. 2, 3, and 4. The structures of these embodiments are generally identical to the first embodiment, except the reflection structure, which is generally designated at 6, 7, and 8 for these embodiments. Regarding to the differences of the second to fourth embodiments from the first embodiment, as shown in FIG. 2, the second embodiment comprises a reflection structure 6 that has a second portion 62 having a circular curved shape; as shown in FIG. 3, the third embodiment of the present invention comprises a reflection structure 7 that has a second portion 72 having a pyramidal shape; and as shown in FIG. 4, the fourth embodiment of the present invention comprises a reflection structure 8 that has a second portion 82 having a planar configuration. Each of the reflection structures 6, 7, 8 has a second joint rim 63, 73, 83 (formed between the first portion 61, 71, 81 and the second portion 62, 72, 82) for detachable engagement with the first joint rim 211 of the cover 2 to be fixed thereto, allowing a user to easily and conveniently remove and replace the reflection structure. In other words, the reflection structure 6, 7, 8 can be removed and substituted by another reflection structure.

In summary, the present invention provides an LED light bulb with large-angle light emission that is characterized in that a reflection structure 1 is provided on a cover 2 in such a way that the reflection structure 1 reflects light to the circumferential portions of the cover 2 to expand the light emission angle of the LED bulb to around 270-330 degrees and to enhance light intensity and brightness at the rear and sides of the LED light bulb. The reflection structure 1, 6, 7, 8 is detachably mounted to the top of the cover 2 so that a user may easily and conveniently remove and replace the reflection structure 1, 6, 7, 8.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An LED light bulb with large-angle light emission, comprising:
a cover;
a reflection structure, which is detachably mounted to a top of the cover;
a heat dissipater, which has a top end coupled to a bottom end of the cover;
a circuit board, which comprises at least one LED element mounted thereon, the circuit board being attached to the heat dissipater in such a way that the circuit board is housed in the cover to allow the at least one LED element to project light toward the cover and the reflection structure; and
a power connector, which is mounted to a bottom end of the heat dissipater.

2. The LED light bulb with large-angle light emission as claimed in claim 1, wherein the circuit board is attached to the top end of the heat dissipater.

3. The LED light bulb with large-angle light emission as claimed in claim 1, wherein the reflection structure comprises a first portion that is exposed outside the cover and a second portion that is located inside the cover.

4. The LED light bulb with large-angle light emission as claimed in claim 3, wherein the second portion of the reflection structure has a circular conic shape.

5. The LED light bulb with large-angle light emission as claimed in claim 3, wherein the second portion of the reflection structure has a circular curved shape.

6. The LED light bulb with large-angle light emission as claimed in claim 3, wherein the second portion of the reflection structure has a pyramidal shape.

7. The LED light bulb with large-angle light emission as claimed in claim 3, wherein the second portion of the reflection structure has a planar configuration.

8. The LED light bulb with large-angle light emission as claimed in claim 1, wherein the cover forms a hole in a top, the reflection structure being detachably mounted in the hole of the cover.

9. The LED light bulb with large-angle light emission as claimed in claim 8, wherein the hole of the cover has an inner circumference along which a first joint rim is formed, the reflection structure having an outer circumference along which a second joint rim is formed to correspond to the first joint rim, the second joint rim of the reflection structure being detachably engageable with the first joint rim of the cover to be fixed thereto.
